(19) United States
(12) Patent Application Publication
(10) Pub. No.: US 2020/0284094 A1
(43) Pub. Date: Sep. 10, 2020

(54) OPERATING SYSTEM FOR AN ARCHITECTURAL-STRUCTURE COVERING

(71) Applicant: Hunter Douglas, Inc., Pearl River, NY (US)

(72) Inventors: Jeffrey L. Spray, Erie, CO (US); Mark Schwandt, Thornton, CO (US)

(73) Assignee: Hunter Douglas, Inc., Pearl River, NY (US)

(21) Appl. No.: 16/795,941

(22) Filed: Feb. 20, 2020

Related U.S. Application Data
(60) Provisional application No. 62/813,898, filed on Mar. 5, 2019.

(51) Int. Cl. E06B 9/90

(52) U.S. Cl. CPC E06B 9/90; E06B 2009/905

(57) ABSTRACT

An operating system for use with an architectural-structure covering for moving a covering portion of the architectural-structure covering between an extended position and a retracted position is disclosed. The operating system may include a drive mechanism (e.g., a drive spool), a driven member operatively coupled to the drive mechanism, a clutch mechanism (e.g., a wrap spring) operatively coupled to the drive mechanism and the driven member, and a collar operatively associated with the clutch mechanism. The collar may be adapted and configured to receive an end portion of the clutch mechanism so that the end portion of the clutch mechanism is encased by the collar.

### CROSS-REFERENCE TO RELATED APPLICATIONS

This is a non-provisional of, and claims the benefit of the filing date of, pending U.S. provisional patent application No. 62/813,898, filed Mar. 5, 2019, entitled “Operating System for an Architectural-Structure Covering,” which application is incorporated by reference herein in its entirety.

### FIELD OF THE DISCLOSURE

The present disclosure relates generally to the field of architectural-structure coverings, and more particularly to methods and apparatuses for an operating system that operates a pull system for moving the covering between extended and retracted positions.

### BACKGROUND

Architectural-structure coverings may selectively cover an architectural structure such as, for example, a window, a doorway, a skylight, a hallway, an archway, a portion of a wall, etc. (collectively an architectural structure without the intent to limit). Generally speaking, architectural-structure coverings may include a covering that can be extendable and retractable, for example, vertically extendable or retractable (e.g., able to be lowered or raised, respectively, in a vertical direction) between an extended position and a retracted position for obscuring and exposing the underlying architectural structure. The architectural-structure covering may further include a bottom rail attached to a lower edge of the covering. The bottom rail may be utilized to add weight along the lower edge of the covering to encourage the covering to drop by gravity during deployment.

To move the covering between the extended and retracted positions, some architectural-structure coverings include a rotatable member (e.g., a rod or a roller). In use, rotation of the rotatable member in a first direction may retract the covering while rotation of the rotatable member in a second, opposite direction may extend the covering. The covering portion of the architectural-structure covering may be gathered or stacked adjacent to, or wrapped around, the rotatable member. For example, some retractable coverings include a plurality of slats that are raised or lowered as lift cords are wrapped about or unwrapped from the rotatable member. The architectural-structure covering may include lift cords which are coupled to the covering portion and the rotatable member. In use, rotation of the rotatable member in a first direction wraps the lift cords about the rotatable member causing the covering portion to retract adjacent to the rotatable member while rotation in a second direction causes the lift cords to unwrap about the rotatable member causing the covering portion to move in an extended configuration. Alternatively, in various embodiment, the covering may be wrapped around the rotatable member in the retracted position. For example, some retractable coverings include a flexible covering suspended from the rotatable member. The covering can either be wrapped about the rotatable member to retract the covering or unwrapped from the rotatable member to extend the covering. Regardless of the form of the retractable covering, rotation of the rotatable member generally causes movement of the covering of the architectural-structure covering. To actuate movement of the rotatable member, and thus the covering of the architectural-structure covering, an operating system may be operably coupled to the rotatable member.

In use, the operating system may be operatively associated with an operating element, for example, a cord, a chain, a tilt wand, or the like. In use, the operating element is manipulated by a human operator to move the covering between the extended and retracted positions.

One known operating system, described in U.S. Pat. No. 6,129,131, utilizes an operating element to drive a unidirectional pull system that intermittently rotates a rotatable member (e.g., a drive shaft) in a single direction to, for example, drive lift cords associated with the covering to raise the covering from the extended position to the retracted position. Gravity is utilized to lower the covering from the retracted position to the extended position.

It is with respect to these and other considerations that the present improvements may be useful.

### SUMMARY

This Summary is provided to introduce a selection of concepts in a simplified form that are further described below in the Detailed Description. This Summary is not intended to identify key features or essential features of the claimed subject matter, nor is it intended as an aid in determining the scope of the claimed subject matter.

Disclosed herein is an operating system for use with an architectural-structure covering for moving a covering portion of the architectural-structure covering between an extended position and a retracted position. The covering portion may be any covering now known or hereafter developed. For example, the covering may be a flexible material which, in use, is capable of being extended or moved away from the rotatable member in an extended position and retracted in a retracted position. The operating system may include an operating element (e.g., a cord, a ball chain, etc.) for retracting or raising the covering portion.

In one embodiment, the operating system may include a drive mechanism operatively coupled to the operating element so that movement of the operating element rotates the drive mechanism, a driven member operatively coupled to the drive mechanism, and a clutch mechanism operatively coupled to the drive mechanism and the driven member. In use, rotation of the drive mechanism in a first direction via, for example, movement of the operating element, is transferred from the drive mechanism to the clutch mechanism to the driven member. Meanwhile, rotation of the drive mechanism in a second, opposite direction via, for example, releasing the operating element, is not transferred from the drive mechanism to the driven member. That is, the clutch mechanism prevents rotation of the drive mechanism in the second direction from being transferred to the driven member.

The operating system may also include a collar operatively associated with the clutch mechanism. In use, the collar is adapted and configured to receive an end portion of the clutch mechanism so that the end portion of the clutch mechanism is encased or enclosed by the collar. In this manner, the end portion of the clutch mechanism is shielded from contacting the housing of the operating system.

In one example of an embodiment, an operating system for use with an architectural-structure covering is disclosed. The operating system is arranged and configured to move a covering portion of the architectural-structure covering between an extended position and a retracted position. The operating system comprises a drive spool, a driven member operatively coupled to the drive spool, a wrap spring operatively coupled to the drive spool and the driven member, the wrap spring including a tail, and a collar adapted and configured to receive an end portion of the wrap spring so that the end portion of the wrap spring is encased by the collar.

In one example of an embodiment, an operating system for use with an architectural-structure covering is disclosed. The operating system is arranged and configured to move a covering portion of the architectural-structure covering between an extended position and a retracted position. The operating system comprises a drive mechanism, a driven member operatively coupled to the drive mechanism, a clutch mechanism operatively coupled to the drive mechanism and the driven member, and a collar operatively associated with the clutch mechanism, the collar being adapted and configured to receive an end portion of the clutch mechanism so that the end portion of the clutch mechanism is encased by the collar.

### BRIEF DESCRIPTION OF THE DRAWINGS

FIG. 1 is a top view of a known operating system including a drive mechanism, a clutch mechanism and a driven member;

FIG. 2 is an exploded, top view of the drive mechanism, the clutch mechanism, and the driven member used in connection with the operating system shown in FIG. 1;

FIG. 3 is a partial, top view of an example embodiment of an improved operating system in accordance with one aspect of the present disclosure, the improved operating system including a collar;

FIG. 4 is a partially, exploded view of the improved operating system shown in FIG. 3;

FIG. 5 is a partially, top view of the improved operating system shown in FIG. 3 positioned with a housing portion;

FIG. 6 is a side view of the collar used in connection with the improved operating system shown in FIG. 3; and

FIG. 7 is a side, perspective view of the collar used in connection with the improved operating system shown in FIG. 3.

### DETAILED DESCRIPTION

Embodiments of an example, illustrative operating system for architectural-structure coverings in accordance with various separate and independent principles of the present disclosure will now be described more fully hereinafter with reference to the accompanying drawings, in which embodiments of the present disclosure are presented. The operating system of the present disclosure may, however, be embodied in many different forms and should not be construed as being limited to the embodiments set forth herein. Rather, these embodiments are provided so that this disclosure will convey certain aspects of the operating system to those skilled in the art. In the drawings, like numbers refer to like elements throughout unless otherwise noted.

As will be generally appreciated by one of ordinary skill in the art, an operating system may be contained within a fully contained module or housing and may support an end of an associated rotatable member. In use, the operating system generally includes a retraction mode and an extension mode. When in the retraction mode, the operating system is operable to raise or retract a covering of the architectural-structure covering. When in the extension mode, the operating system is operable to lower or extend the covering of the architectural-structure covering. The operating system may utilize an operating element, such as a cord, a ball chain, etc. The operating element may include a connector attached to a free end thereof for coupling to, for example, a wand or flexible cord. In use, the operating system may be operatively associated with one or more lift cords in the architectural-structure covering that extends through or are adjacent to the covering. The lift cords are secured at their upper end to associated cord spools that are rotatably driven by a rotatable member such as, for example, a drive shaft. In use, the operating system is used to rotate the rotatable member that in turn rotates the cord spools causing the covering to retract.

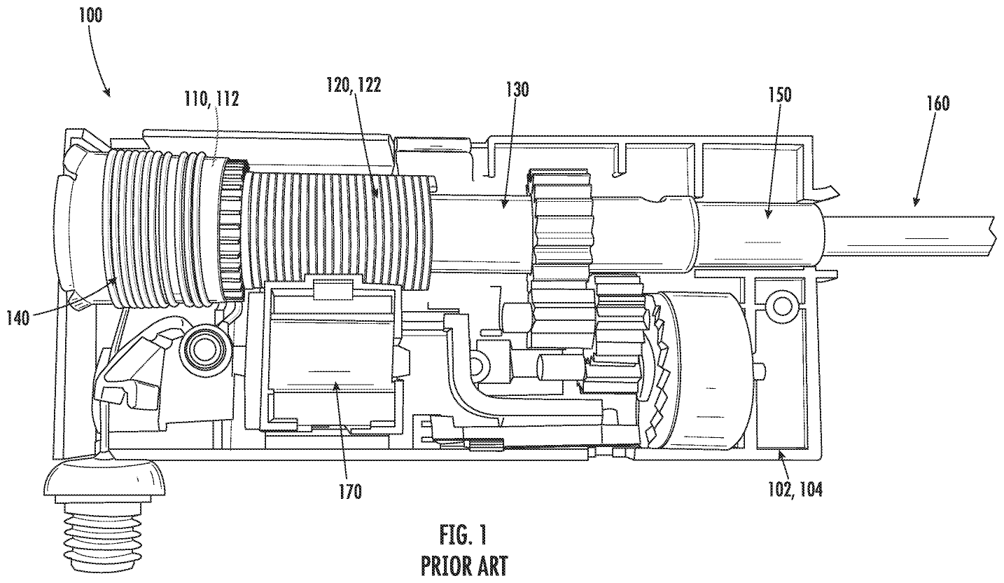

One known operating system used to affect the desired operation of the covering is illustrated in FIG. 1. As illustrated, the operating system 100 includes a housing 102, a drive mechanism 110, a clutch mechanism 120, and a driven member 130 operatively coupled to the drive mechanism 110. The operating system 100 including the drive mechanism 110, the clutch mechanism 120, and the driven member 130 are positioned within the housing 102. The housing 102 includes a first housing portion or base 104 and a second housing portion or cover (not illustrated). In use, the first and second housing portions are operatively coupled to each other such as, for example, via one or more interlocking projections and recesses.

In the illustrated embodiment, the drive mechanism 110 is operatively associated with the operating element 140 so that movement of the operating element 140 rotates the drive mechanism 110. In the illustrated embodiment, the drive mechanism 110 is in the form of a drive spool 112. In use, the operating element 140 is coupled to and wrappable about the drive spool 112 so that pulling the operating element 140 rotates the drive spool 112 for retracting the covering.

As illustrated, the clutch mechanism 120 is a wrap spring 122. In use, the clutch mechanism 120 is coupled to the drive mechanism 110 (e.g., drive spool 112) and the driven member 130 so that when the operating element 140 is pulled, the drive spool 112 is rotated in a first direction, which in turn rotates the clutch mechanism 120 that in turn rotates the driven member 130. For example, with the clutch mechanism 120 in the form of a wrap spring 122, rotation of the drive spool 112 in a first direction by pulling on the operating element 140 causes the wrap spring 122 to tension or tighten against an outer circumference of the drive spool 112 and an outer circumference of the driven member 130 so that rotation of the drive spool 112 is transferred to the driven member 130 (e.g., rotation of the drive spool 112 rotates the driven member 130). Meanwhile, rotation of the drive spool 112 in a second or opposite direction say, for example, by releasing the operating element 140, causes the wrap spring 122 to un-tension or loosen from the outer circumference of the drive spool 112 and the outer circumference of the driven member 130 so that reverse rotation of the drive spool 112 is not transferred to the driven member 130 (e.g., rotation of the drive spool 112 does not rotate the driven member 130).

As will be appreciated by one of ordinary skill in the art, the driven member 130 is coupled to an output assembly 150 for coupling to the rotatable member, which is in the form of a drive shaft, (schematically illustrated as 160) so that rotation of the driven member 130 in the first direction rotates the rotatable member 160, which in turn is operatively coupled to the covering so that rotation of the rotatable member 160 operates (e.g., moves) the covering. Meanwhile, the operating system 100 may also include a return spring 170 to facilitate retraction of the operating element 140. In use, extension (e.g., pulling) of the operating element 140 causes the return spring 170 to coil up. Release of the lift cords causes the return spring 170 to rotate the driven member 130, causing the operating element 140 to retract and wrap about the drive spool 112. The operating system 100 may also include a clutch/brake assembly that is operatively connected to the driven member 130 to grip the driven member 130 when it would otherwise be allowed to rotate in the second direction or the direction in which the covering would drop toward an extended position.

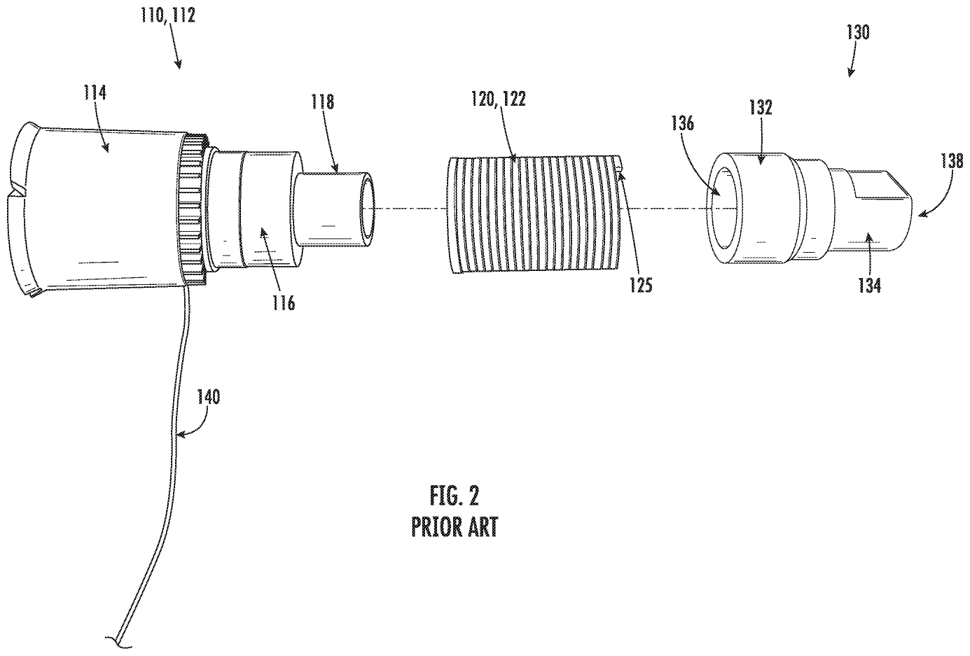

Referring to FIG. 2, additional detailed information regarding the illustrated, known drive spool 112, driven member 130, and wrap spring 122 will be described. As illustrated, the drive spool 112 includes a first segment 114 for receiving at least a portion of the operating element 140, a second segment 116 for interacting with the wrap spring 122, and a third segment 118 for interacting with the driven member 130. As illustrated, the first segment 114 has a larger diameter than the second segment 116, which has a larger diameter than the third segment 118. That is, the first segment 114 has a first diameter, the second segment 116 has a second diameter, and the third segment 118 has a third diameter, the first diameter is larger than the second diameter, and the second diameter is larger than the third diameter.

Similarly, the driven member 130 has a first segment 132 and a second segment 134. The first segment 132 has a first diameter, and the second segment 134 has a second diameter, the first diameter being larger than the second diameter. When coupled, the first segment 132 of the driven member 130 has an outer diameter substantially similar to the outer diameter of the second segment 116 of the drive spool 112 so that when assembled, the wrap spring 122 overlies and interacts with the second segment 116 of the drive spool 112 and the first segment 132 of the driven member 130, as previously described. In the illustrated embodiment, the first segment 132 of the driven member 130 includes a cavity 136 formed in an end thereof for receiving the third segment 118 of the drive spool 112. In addition, the second segment 134 of the driven member 130 includes a coupling mechanism 138 such as, for example, a cavity for engaging the output assembly 150.

Additional information on the structure and operation of the operating system 100 and the components thereof, can be found in U.S. Pat. No. 6,129,131 entitled “Control System for Coverings for Architectural Openings”.

One common issue associated with the operating system of FIG. 1 is that the first and second housing portions (first housing portion 104 shown in FIG. 1) of the operating system 100 may be misaligned due to, for example, imperfect tolerances. As a result, an end or tail 125 (FIG. 2) of the wrap spring 122 may hit or snag a surface formed at the meeting of the mis-aligned first and second housing portions of the operating system 100. In turn, this may result in improper operation and/or unwanted noise. For example, during operation, a detectable clicking sound may be heard for every revolution of the wrap spring 122 as the tail 125 is rotated against a surface formed by the mis-aligned first and second housing portions of the operating system 100. That is, for example, as a result of mis-aligned first and second housing portions, a surface, lip, wall, projection, or the like may be formed in a path of the tail 125 of the wrap spring 122. Rotation of the wrap spring 122 causing the tail 125 to contact the surface, lip, wall, projection, or the like thus causing, for example, unwanted noise. This noise often results in consumer complaints and product returns.

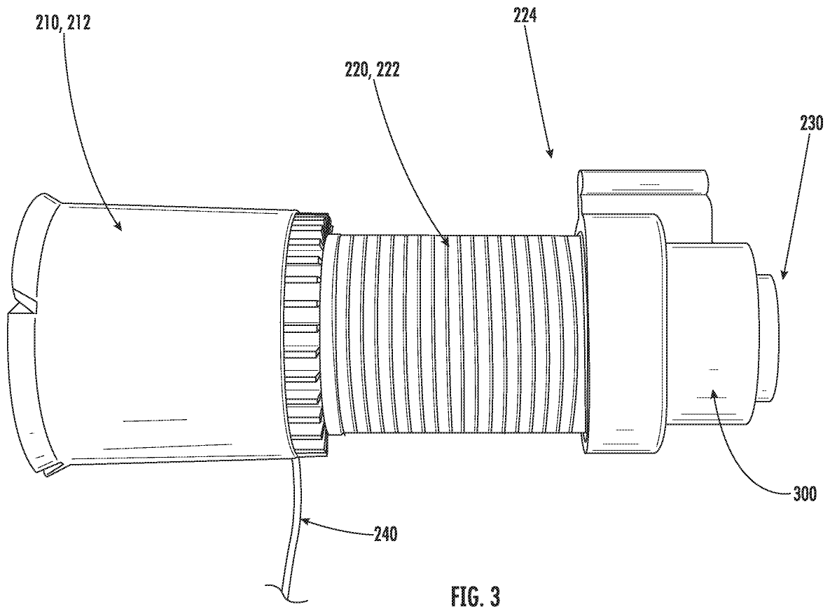

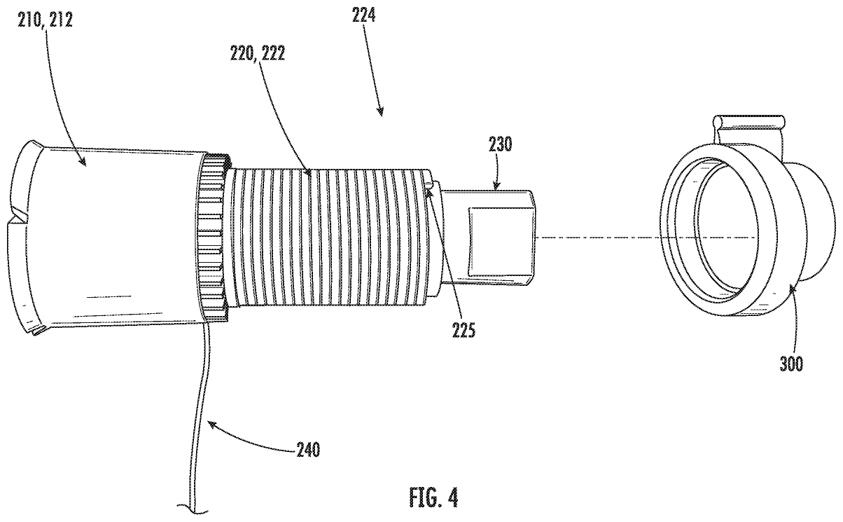

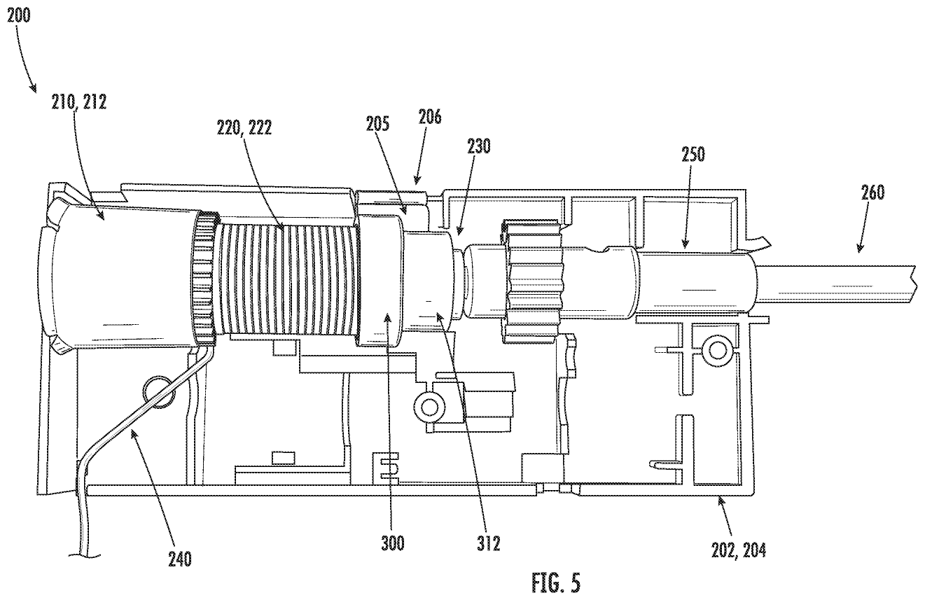

Referring to FIGS. 3-5, in accordance with one aspect of the present disclosure, an improved operating system 200 (FIG. 5) is disclosed. In the illustrated embodiment, the operating system 200 includes, inter alia, a housing 202, a drive mechanism 210 (e.g., drive spool 212), a clutch mechanism 220 (e.g., wrap spring 222), a driven member 230, an operating element 240, and an output assembly 250. In use, the operating system 200, including the housing 202, the drive mechanism 210 (e.g., drive spool 212), the clutch mechanism 220 (e.g., wrap spring 222), the driven member 230, the operating element 240, and the output assembly 250, are substantially similar to the housing 102, the drive mechanism 110 (e.g., drive spool 112), the clutch mechanism 120 (e.g., wrap spring 122), the driven member 130, the operating element 140, and the output assembly 150 described above in connection with FIGS. 1 and 2 except as described herein. As such, detailed description of the housing 202, the drive mechanism 210 (e.g., drive spool 212), the clutch mechanism 220 (e.g., wrap spring 222), the driven member 230, the operating element 240, and the output assembly 250 are omitted for the sake of brevity.

In addition, as illustrated, the operating system 200 includes a bushing, a collar, or the like 300 (collectively referred to as a collar herein without the intent to limit). In use, the collar 300 is adapted and configured to receive an end portion 224 of the wrap spring 222, for example, the end portion 224 including a tail 225 of the wrap spring 222, so that the edge of the wrap spring 222 is covered and thereby shielded from contacting, for example, the first and second housing portions of the operating system 200. That is, in one embodiment, the collar 300 is adapted and configured to receive an end portion 224 of the wrap spring 222 so that the end portion 224 of the wrap spring 222 is encased or enclosed by the collar 300.

Additionally, in use, incorporation of the collar 300 facilitates manufacturing of the collar 300 from a first lubricated material while enabling the housing 202 of the operating system 200 to be manufactured from a second lubricated material. For example, in one example embodiment, the collar 300 can be manufactured from a higher lubricated grade of material while enabling the housing 202 to be manufactured from a lesser lubricated grade of material, and thus a less expensive material. For example, the housing 202 may be manufactured from a non-lubricated material. Moreover, the collar 300 ensures that proper friction/drag with the wrap spring 222 is achieved to ensure proper operation of the operating system 200.

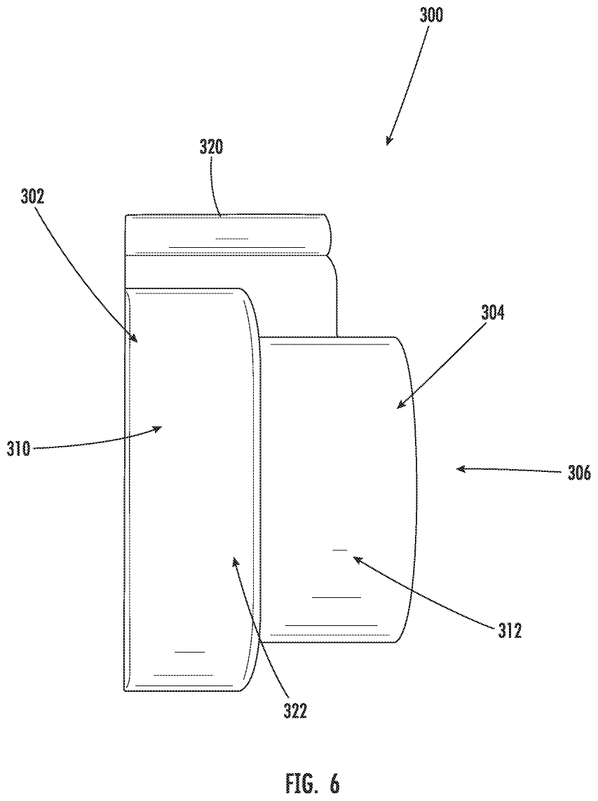

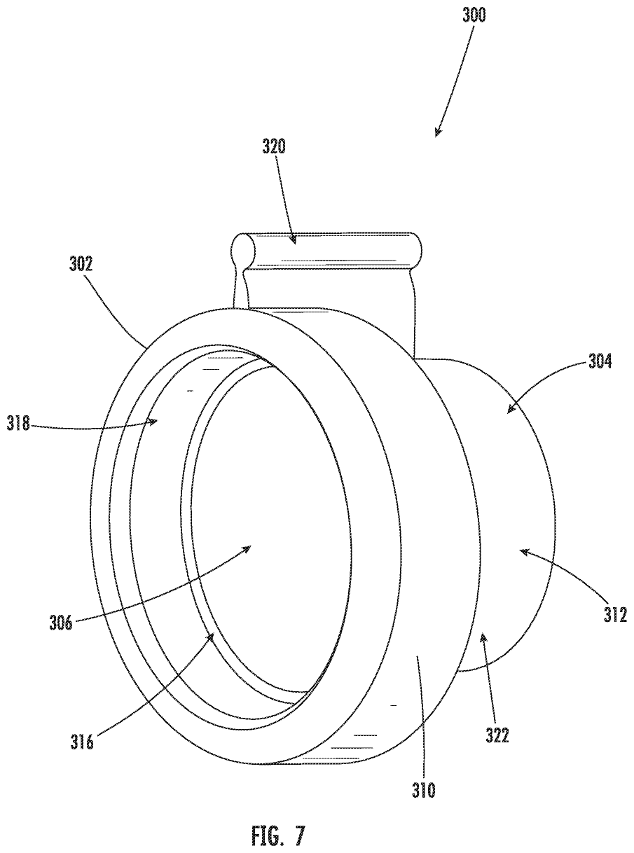

Referring to FIGS. 6 and 7, in the illustrated example embodiment, the collar 300 includes a first end 302, a second end 304, and a through bore 306 extending from the first end 302 to the second end 304. In use, the through bore 306 is adapted and configured to enable the driven member 230 to pass through so that the driven member 230 may be coupled, either directly or indirectly, to the rotatable member (schematically illustrated as 260).

As illustrated in the example embodiment, the collar 300 may include a first segment 310 adjacent to the first end 302 thereof and a second segment 312 adjacent to the second end 304 thereof. In use, the first segment 310 may be diametrically larger than the second segment 312. That is, the first segment 310 has a first diameter and the second segment 312 has a second diameter, the first diameter being larger than the second diameter. As such, an internally protruding shoulder 316 (FIG. 7) may be formed in the through bore 306 between the larger diameter first segment 310 and the smaller diameter second segment 312. In use, the internally protruding shoulder 316 creates a stop or resting surface for the end portion 224 of the wrap spring 222. Meanwhile, as illustrated in FIGS. 3 and 5, the through bore 306 enables the driven member 230 to pass therethrough. As illustrated, the first segment 310 may include an inner surface 318. In one embodiment, the inner surface 318 has a smooth surface for contacting the wrap spring 222. In this manner, due to the lubrication of the collar 300, minimal friction exists between the inner surface 318 of the collar 300 and the wrap spring 222. In use, the collar 300 may be keyed to the housing 202 (e.g., first housing portion 204) so that the collar 300 is prevented from rotation relative to the first housing portion 204. For example, the collar 300 may include a projection 320 extending from an outer surface 322 thereof for interacting with the first housing portion 204 to prevent relative rotation between the collar 300 and the first housing portion 204 so that, in use, relative rotation of the drive spool 212 via pulling the operating element 240 causes, inter alia, the wrap spring 222 to tension. That is, in use, the collar 300 is adapted and configured to be seated within the first housing portion 204. For example, as illustrated in FIG. 5, the second segment 312 of the collar 300 may be received within a corresponding arcuate seat 205 formed in the first housing portion 204. In use, the seat 205 provides increased support of the collar 300, drive spool 212, driven member 230, and wrap spring 222 thus resulting in less bending of the overall assembly of components. In order to prevent relative rotation of the collar 300 with respect to the first housing portion 204, the projection 320 formed on the collar 300 may contact a corresponding groove 206 formed in the first housing portion 204.

In use, with relative rotation of the collar 300 and the first housing portion 204 prevented, rotation of the drive spool 212 in a first (e.g., counter-clockwise) direction via, for example, pulling on the operating element 240, causes the wrap spring 222 to rotate, which causes the wrap spring 222 to tension or tighten (e.g., wind up or clamp down) about an outer circumference of the drive spool 212 and an outer circumference of the driven member 230 so that rotation of the drive spool 212 rotates the driven member 230 (e.g., the drive spool 212, the wrap spring 222, and the driven member 230 rotate in unison). Meanwhile, rotation of the drive spool 212 in a second (e.g., clockwise) direction via, for example, by releasing the operating element 240, causes the wrap spring 222 to un-tension or loosen (e.g., unwind or release) from the outer circumference of the drive spool 212 and the outer circumference of the driven member 230 so that reverse rotation of the drive spool 212 is not transferred to the driven member 230 (e.g., the drive spool 212 rotates relative to the wrap spring 222 and the driven member 230 so that rotation of the drive spool 212 is not transferred to the wrap spring 222 and the driven member 230). Thus, in use, rotation of the drive spool 212 in the first direction causes the wrap spring 222 to rotate and tension, which causes the wrap spring 222 to constrict about the drive spool 212 so that rotation is transferred between the drive spool 212 and the driven member 230. Rotation of the drive spool 212 in the second direction causes the wrap spring 222 to come out of tension and thus expand slightly, allowing the drive spool 212 to rotate inside of and relative to the wrap spring 222 so that rotation is not transferred between the drive spool 212 and the driven member 230.

The foregoing description has broad application. For example, although wrap springs and one type of clutch mechanism have been discussed, other suitable elements may be used. Additionally, the example operating system may be used with any type of shade, including, but not limited to, roller and stackable shades. Furthermore, the example operating module or system may be used in association with either end of a head rail. Accordingly, the discussion of any embodiment is meant only to be explanatory and is not intended to suggest that the scope of the disclosure, including the claims, is limited to these examples. In other words, while illustrative embodiments of the disclosure have been described in detail herein, it is to be understood that the inventive concepts may be otherwise variously embodied and employed, and that the appended claims are intended to be construed to include such variations, except as limited by the prior art.

The foregoing discussion has been presented for purposes of illustration and description and is not intended to limit the disclosure to the form or forms disclosed herein. For example, various features of the disclosure are grouped together in one or more aspects, embodiments, or configurations for the purpose of streamlining the disclosure. However, it should be understood that various features of the certain aspects, embodiments, or configurations of the disclosure may be combined in alternate aspects, embodiments, or configurations. Moreover, the following claims are hereby incorporated into this Detailed Description by this reference, with each claim standing on its own as a separate embodiment of the present disclosure.

The phrases “at least one”, “one or more”, and “and/or”, as used herein, are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity, as used herein, refers to one or more of that entity. As such, the terms “a” (or “an”), “one or more” and “at least one” can be used interchangeably herein.

The use of “including,” “comprising,” or “having” and variations thereof herein is meant to encompass the items listed thereafter and equivalents thereof as well as additional items. Accordingly, the terms “including,” “comprising,” or “having” and variations thereof are open-ended expressions and can be used interchangeably herein.

All directional references (e.g., proximal, distal, upper, lower, upward, downward, left, right, lateral, longitudinal, front, back, top, bottom, above, below, vertical, horizontal, radial, axial, clockwise, and counterclockwise) are only used for identification purposes to aid the reader's understanding of the present disclosure, and do not create limitations, particularly as to the position, orientation, or use of this disclosure. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other. Identification references (e.g., primary, secondary, first, second, third, fourth, etc.) are not intended to connote importance or priority but are used to distinguish one feature from another. The drawings are for purposes of illustration only and the dimensions, positions, order and relative sizes reflected in the drawings attached hereto may vary.

1. An operating system for use with an architectural-structure covering, the operating system being arranged and configured to move a covering portion of the architectural-structure covering between an extended position and a retracted position, the operating system comprising:
a drive spool;
a driven member operatively coupled to the drive spool;
a wrap spring operatively coupled to the drive spool and the driven member, the wrap spring including a tail; and
a collar adapted and configured to receive an end portion of the wrap spring so that the end portion of the wrap spring is encased by the collar.

2. The operating system of claim 1, wherein, in use, rotation of the drive spool in a first direction causes the wrap spring to tension, rotation of the drive spool in a second, opposite direction causes the wrap spring to un-tension.

3. The operating system of claim 1, wherein the collar includes a first end, a second end, and a through bore extending from the first end to the second end, the through bore is adapted and configured to enable the driven member to pass through the collar so that the driven member can be coupled to a rotatable member.

4. The operating system of claim 3, wherein the collar includes a first segment having a first diameter and a second segment having a second diameter, the first diameter being larger than the second diameter.

5. The operating system of claim 4, wherein the collar includes an internally protruding shoulder formed in the through bore, the internally protruding shoulder forming a stop arranged and configured to receive the end portion of the wrap spring.

6. The operating system of claim 1, further comprising a housing, the drive spool, the driven member, the wrap spring, and the collar being positioned within the housing, the collar being keyed to the housing so that the collar is prevented from rotating relative to the housing.

7. The operating system of claim 6, wherein the collar includes a projection extending from an outer surface of the collar, the projection interacting with the housing to prevent relative rotation between the collar and the housing.

8. The operating system of claim 6, wherein the collar is manufactured from a lubricated material.

9. The operating system of claim 8, wherein the housing is manufactured from a non-lubricated material.

10. The operating system of claim 1, wherein the drive spool is operatively associated with an operating element, the operating element being coupled to and wrappable about the drive spool so that movement of the operating element rotates the drive spool to move the covering portion of the architectural-structure covering from the extended position to the retracted position.

11. The operating system of claim 10, wherein movement of the operating element in a first direction causes the drive spool to rotate in the first direction causing the wrap spring to tension against an outer circumference of the drive spool and an outer circumference of the driven member so that rotation of the drive spool rotates the driven member, and rotation of the drive spool in a second, opposite direction causes the wrap spring to un-tension releasing the outer circumference of the drive spool and the driven member so that reverse rotation of the drive spool is not transferred to the driven member.

12. An operating system for use with an architectural-structure covering, the operating system arranged and configured to move a covering portion of the architectural-structure covering between an extended position and a retracted position, the operating system comprising:
a drive mechanism;
a driven member operatively coupled to the drive mechanism;
a clutch mechanism operatively coupled to the drive mechanism and the driven member; and
a collar operatively associated with the clutch mechanism, the collar being adapted and configured to receive an end portion of the clutch mechanism so that the end portion of the clutch mechanism is encased by the collar.

13. The operating system of claim 12, wherein the collar includes a first end, a second end, and a through bore extending from the first end to the second end, the through bore is adapted and configured to enable the driven member to pass through the collar so that the driven member can be coupled to a rotatable member.

14. The operating system of claim 13, wherein the collar includes a first segment having a first diameter and a second segment having a second diameter, the first diameter being larger than the second diameter.

15. The operating system of claim 14, wherein the collar includes an internally protruding shoulder formed in the through bore, the internally protruding shoulder forming a stop arranged and configured to receive the end portion of the clutch mechanism.

16. The operating system of claim 12, further comprising a housing, the drive mechanism, the driven member, the clutch mechanism, and the collar being positioned within the housing, the collar being keyed to the housing so that the collar is prevented from rotating relative to the housing.

17. The operating system of claim 16, wherein the collar includes a projection extending from an outer surface of the collar, the projection interacting with the housing to prevent relative rotation between the collar and the housing.

18. The operating system of claim 16, wherein the collar is manufactured from a lubricated material and the housing is manufactured from a non-lubricated material.
